(19) United States
(12) Patent Application Publication
(10) Pub. No.: US 2026/0355844 A1
(43) Pub. Date: Nov. 12, 2026

(54) INLINE WELDING TORCH

(71) Applicant: Lincoln Global, Inc., Cleveland, OH (US)

(72) Inventors: Alexander J. Stergios, Independence, OH (US); Miguel A. Espiricueta Ulloa, Torreón (MX); Donald A. Dragolich, Huntsburg, OH (US)

(21) Appl. No.: 19/200,809

(22) Filed: May 7, 2025

(51) Int. Cl. B23K 9/29; B23K 9/167

(52) U.S. Cl. CPC B23K 9/296; B23K 9/167

(57) ABSTRACT

A welding torch includes an elongated body having a longitudinal axis and defining a cavity therein. The cavity extends in a longitudinal direction and is dimensioned to receive a non-consumable electrode therein. A head is removably attached to a distal end of the main body such that each of the head and the elongated body is aligned along the longitudinal axis. The head is configured to secure the non-consumable electrode when the head is attached to the elongated body.

### FIELD

The present disclosure generally relates to welding torches, and more particularly an inline TIG welding torch configured to accommodate standard non-consumable electrode sizes.

### BACKGROUND

Tungsten inert gas (TIG) welding is a high-precision process that demands significant skill and dexterity. Conventional TIG welding torches typically include a main body that defines a handle and a torch head disposed at an end of the main body. The torch head defines a cavity dimensioned to accommodate and retain various expendable components therefrom, for example, a collet, a collet body, and a non-consumable electrode (e.g., tungsten). Such torches also feature a back cap with a cavity dimensioned to accommodate a rear portion of the non-consumable electrode. The back cap, torch head, and electrode are generally aligned along a first axis, while the main body extends from the torch head along a second axis, defining an angle of about 50-80 degrees relative to the first axis. The back cap, which protrudes rearwardly from the torch head, often makes conventional TIG torches cumbersome to operate, particularly in confined spaces. To address this issue, inline TIG welding torches (also known as “pencil-style” torches) were developed with a more streamlined design. With these torches, the main body, which serves as a grip/handle, is aligned along the same longitudinal axis as the non-consumable electrode. While this configuration improves maneuverability, it introduces certain limitations, particularly in the length of the tungsten electrode that can be utilized for the welding process. Specifically, such torches generally do not utilize a back cap to accommodate a rear portion of the electrode. This requires the user to cut standard-length non-consumable electrodes (e.g., generally sold in 7 inch cut lengths) into smaller segments, resulting in material waste and potential contamination. It is desirable to provide an inline TIG welding torch configured to alleviate the foregoing issues.

### SUMMARY

The following summary presents a simplified summary in order to provide a basic understanding of some aspects of the devices and assemblies described herein. This summary is not an extensive overview of the devices and assemblies described herein, and is not intended to identify critical elements or to delineate the scope of such devices or assemblies. Its sole purpose is to present some concepts in a simplified form as a prelude to the more detailed description that is presented later.

In accordance with a first aspect, there is provided a welding torch including an elongated body. The elongated body has a longitudinal axis and defines a cavity therein. The cavity extends in a longitudinal direction and is dimensioned to receive a non-consumable electrode therein. A head is configured to be removably attached to a distal end of the elongated body such that each of the head and the elongated body is aligned along the longitudinal axis. The head is configured to secure the non-consumable electrode when the head is attached to the distal end of the elongated body.

In an embodiment, the body includes at least one utility line extending in the longitudinal direction. The at least one utility line is spaced from the cavity in a direction orthogonal to the longitudinal direction and extends parallel relative to the cavity.

In an embodiment, wherein the body includes a polymeric material that is overmolded onto the at least one utility line, wherein the polymeric material defines the cavity.

In an embodiment, the at least one utility line includes a power utility line, a gas utility line, and a coolant utility line. The cavity is coaxial with the longitudinal axis of the elongated body. Each of the power utility line, the gas utility line, and the coolant utility line extends in the longitudinal direction and is spaced from the cavity in a direction orthogonal to the longitudinal direction.

In an embodiment, the head includes a rigid insert therein, and the body includes a utility interface configured to receive a distal end of the at least one utility line. The utility interface is configured to engage the rigid insert to removably attach the head to the main body.

In an embodiment, the head is configured to receive a collet therein to inhibit the non-consumable electrode from longitudinal movement when the head is attached to the main body.

In an embodiment, the body includes a utility interface defining a portion of the cavity.

In an embodiment, the body includes a utility interface therein. The utility interface includes a body with a stem protruding outwardly therefrom in the longitudinal direction. The stem defines at least one slot dimensioned to enable shielding gas to flow from the utility interface to the head.

In an embodiment, the body includes a utility interface therein, and the head includes a rigid insert therein defining an opening. The utility interface includes a first body with a stem extending outwardly therefrom in the longitudinal direction. The stem is configured to rotatably engage the opening of the rigid insert to attach the head to the body.

In an embodiment, the utility interface includes a second annular body affixed to the first body. The first body and the second annular body define an annular cavity therein for the passage of coolant.

In an embodiment, the head includes a rigid insert therein, and the rigid insert is overmolded with a polymeric material.

In an embodiment, the head and the elongated body collectively define a cavity therein dimensioned to accommodate a tungsten electrode having a length of at least about six inches.

In accordance with another aspect, there is provided a GTAW torch including a body and a head configured to be removably attached to the body. The body defines an elongated cavity therein extending longitudinally along a major length of the body. Each of the body and the head is aligned along a longitudinal axis of the body, and the elongated cavity is dimensioned to receive a non-consumable electrode therein.

In an embodiment, the body includes a utility line therein, and the utility line defines the elongated cavity.

In an embodiment, the utility line is configured to supply shielding gas to the head via the elongated cavity.

In an embodiment, the utility line is configured to transmit welding current to the head.

In an embodiment, the head includes a rigid insert therein comprising a conductive material. The rigid insert is configured to transmit welding current to the non-consumable electrode via an expendable received by the rigid insert.

In an embodiment, the elongated cavity is dimensioned to accommodate a portion of a tungsten electrode therein having a length that is at least about six inches.

In accordance with another aspect, a pencil-style welding torch includes an overmolded body and an overmolded head. The overmolded body extends along a longitudinal axis and defines a central cavity therein extending in a longitudinal direction. The central cavity is dimensioned to accommodate a portion of a non-consumable electrode comprising a length of at least about six inches.

In an embodiment, the overmolded head is configured to be removably attached to the body to inhibit the non-consumable electrode from longitudinal movement when the overmolded head is attached to the overmolded body.

In an embodiment, the overmolded first body includes at least one utility line and a utility interface therein. The utility interface is configured to receive an end of the at least one utility line. The overmolded head includes a rigid insert therein configured to connect to the utility interface to transmit welding current from the utility interface to the rigid insert.

Numerous aspects of the general inventive concepts will become readily apparent from the following detailed description of exemplary embodiments, from the claims, and from the accompanying drawings.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a perspective view of an example welding torch according to the present disclosure;

FIG. 2 is a perspective view of the welding torch of FIG. 1, wherein the body is shown as transparent to illustrate internal features of the torch;

FIG. 3 is an exploded view of the welding torch of FIG. 1, illustrating a utility line assembly and a rigid insert separated from a molded body and a molded head of the welding torch;

FIG. 4 is a perspective view of an example flange of the utility line assembly of FIG. 3;

FIG. 5 is a perspective view of an example utility interface of the utility line assembly of FIG. 3 shown in relation to a rigid insert of the head;

FIG. 6 is a sectional view of the utility interface taken along line 6-6 in FIG. 5 shown in a state wherein the utility interface is received by the rigid insert;

FIG. 7 is a perspective view of another example welding torch according to the present disclosure; and

FIG. 8 is a sectional view of the welding torch of FIG. 7 taken along line 8-8 of FIG. 7.

### DETAILED DESCRIPTION

The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one,” “one or more,” and “and/or” are open-ended expressions that are both of including one of the terms, either of the terms, or both terms. For example conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities, the phrase “A or B” should be understood to include the possibilities of “A” or “B” or “A and B.”

Herein, the terms “substantially,” “about,” and variations thereof are intended to denote that the described features are equal or approximately equal to a value or characteristic, as desired, reflecting tolerances, conversion factors, rounding off, measurement error and the like, and other factors. For example, the terms “substantially,” “about,” and variations thereof can denote values or characteristics that are exact or within 10% of exact, for example within 5% of exact, or within 2% of exact.

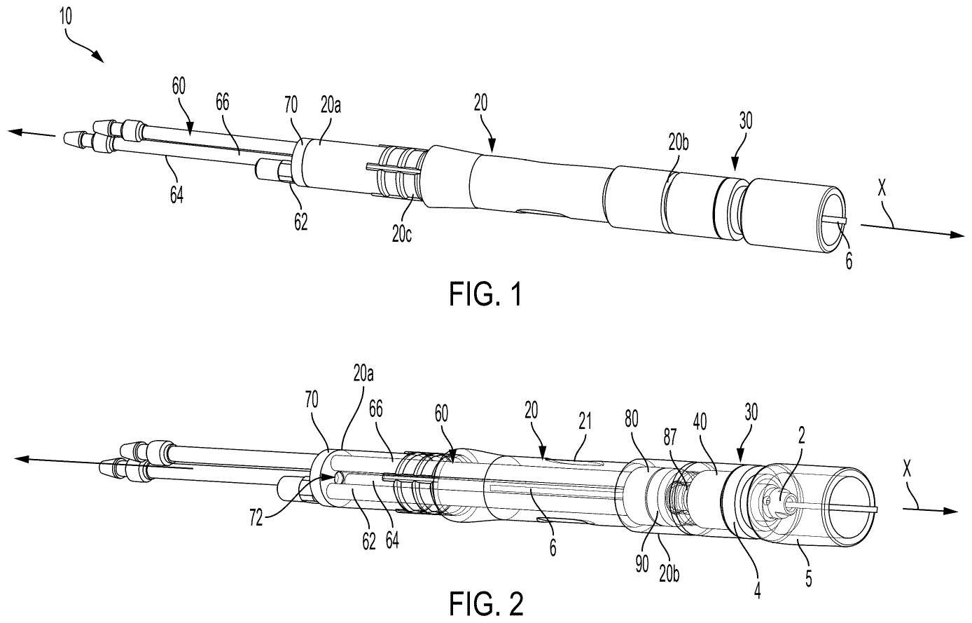

Referring to FIGS. 1 and 2, an example welding torch 10 according to the present disclosure is shown. In general, the welding torch 10 includes a main body 20 and a head 30 configured to be removably attached to the main body 20. An outer surface 20c of the main body 20 may define a gripping surface or handle to manipulate the welding torch 10. The head 30 may be configured to house torch expendables (e.g., a collet, collet body) of the welding torch 10 that are adapted to secure a non-consumable electrode therefrom, as discussed in detail below. In the embodiment shown, the main body 20 and the head 30 each extend linearly and are aligned a longitudinal axis x of the welding torch 10 (e.g., a longitudinal axis of the main body). In this manner, the welding torch 10 may also be referred to as an “inline” or “pencil-style” gas tungsten arc welding (GTAW) torch.

The main body 20 includes a utility line assembly 60 therein that is configured to supply utilities (e.g., shielding gas, a welding current, and optionally coolant) to the head 30. The main body 20 is also configured to receive and accommodate a portion of a non-consumable electrode (not shown) therein, e.g., a tungsten-based electrode to facilitate a GTAW process.

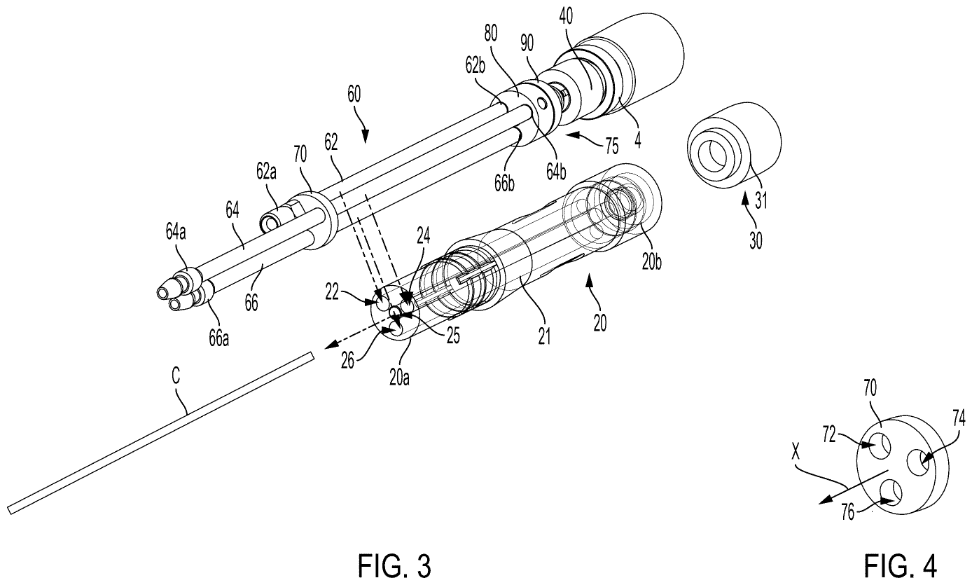

As shown in FIGS. 2 and 3, the main body 20 may embody an elongated, polymeric body 21 (comprising a polymeric material) that is formed during an injection molding process, for example, via an overmolding process to overmold or otherwise encapsulate the utility line assembly 60 and a core C each extending in a longitudinal direction. For the purposes of this disclosure, reference to a “longitudinal” direction or “longitudinal” feature means that the direction or feature extends in a direction substantially parallel to the longitudinal axis x of the welding torch 10 or coaxial with the longitudinal axis x of the welding torch 10.

The polymeric body 21 may be made by introducing a molten, polymeric material (e.g., a silicone material, a thermoplastic material, a thermosetting plastic material, etc.) into a mold cavity (containing the utility line assembly 20 and the core C) such that the polymeric material flows around the utility line assembly 60 (thereby defining cavities 22, 24, and 26 (FIG. 3) for utility lines 62, 64, and 66 thereof) and around the core C (thereby defining a central cavity 25 for a non-consumable electrode when the core C is removed). Yet, it is contemplated that the main body 20 may take on other forms for accommodating a utility line assembly and a non-consumable electrode. For instance, the main body 20 may define a single, longitudinal cavity for housing the utility line assembly and the non-consumable electrode, for example, a clam-shell plastic-injected body (with a living hinge) configured to wrap around and enclose the utility line assembly and the non-consumable electrode. In another embodiment (described below), the main body 20 may comprise a polymeric body (formed during an injection molding process) defining a single, longitudinal cavity to accommodate the utility line assembly and the non-consumable electrode.

Referring to FIG. 2, the utility line assembly 60 is configured to supply utilities to the head 30. For this purpose, the utility line assembly 60 may include a gas line 62 configured to supply shielding gas to the head 30, and a power line 64 configured to supply current to the head 30. In the embodiment shown, the utility line assembly 60 also includes a coolant supply line 66, and the power line 64 defines a coolant return line (defined by an internal cavity thereof). In this manner, the power line 64 may be referred to as a power/coolant return line 64 referring to the welding torch 10 of the present embodiment. Although it should be understood that the utility line assembly 60 may only include a gas line 62 and a power line 64 (devoid of a coolant line), for instance, in embodiments wherein the welding torch 10 is an air-cooled torch. As shown in FIG. 3, the utility lines 62, 64, and 66 may include connectors 62a, 64a, and 66a (e.g., threaded fittings), respectively configured to attach to mating connectors in a cable assembly (not shown) of the welding torch 10.

Referring to 2 and 3, the utility line assembly 60 may include a rigid flange 70 disposed at a proximal end 20a of the main body 20. As shown in FIG. 4, the flange 70 may define pass-through openings 72, 74, and 76 dimensioned to receive the gas, power/coolant return, and coolant supply lines (62, 64, and 66, respectively) therethrough. In some embodiments, the flange 70 may also serve to preserve the spatial integrity and space between the lines 62, 64, and 66 (e.g., the space between the lines 62, 64, and 66 as measured in a direction orthogonal to the longitudinal axis x).

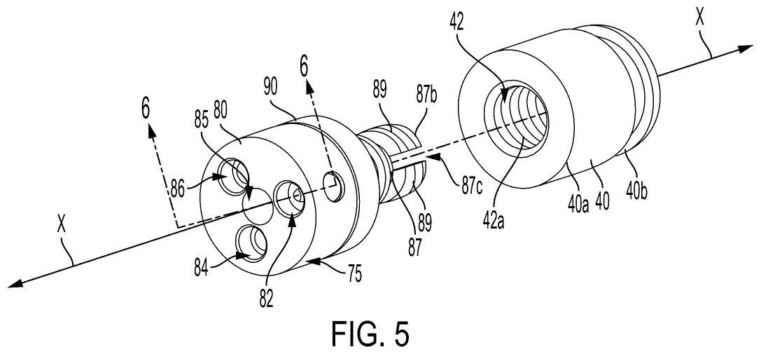

Referring to FIGS. 3 and 5, the utility line assembly 60 may include a utility interface 75 with a first body 80 (e.g., a cylindrical body) and an annular, second body 90 affixed (e.g., brazed) to the first body 80. The first body 80 may be configured to receive or otherwise connect to the gas, power/coolant return, and coolant supply lines 62, 64, and 66 (FIG. 3), respectively. For this purpose, the first body 80 (FIG. 5) may define a plurality of openings 82, 84, and 86 dimensioned to receive distal ends 62b, 64b, and 66b (FIG. 3) of the respective gas, power/coolant return, and coolant supply lines 62, 64, and 66 therein.

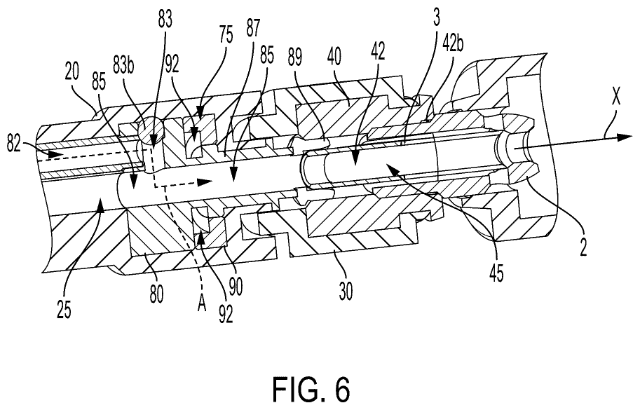

Referring to FIGS. 3, 5 and 6, the power/coolant return line 64 and coolant supply line 66 may fluidly communicate with an annular cavity 92 (FIG. 6) in the second body 90 that is enclosed by the first body 80, e.g., when the second body 90 is attached (e.g., brazed) to the first body 80. In this manner, coolant (supplied via the coolant supply line 66) may be circulated through the annular cavity 92 to extract heat to conductively cool the head 30 of the torch, whereupon the coolant may return to an external supply source (e.g., a cooler) via the power/coolant return 64 line.

The first body 80 may define a central cavity 85 (FIG. 5) extending in a longitudinal direction that is dimensioned to receive a portion of a non-consumable electrode therethrough, as discussed in detail below. The central cavity 85 is substantially coaxial with the central cavity of the main body 25. This aspect of the present disclosure is particularly beneficial for enabling the use of a standard length non-consumable electrode, as discussed in detail below.

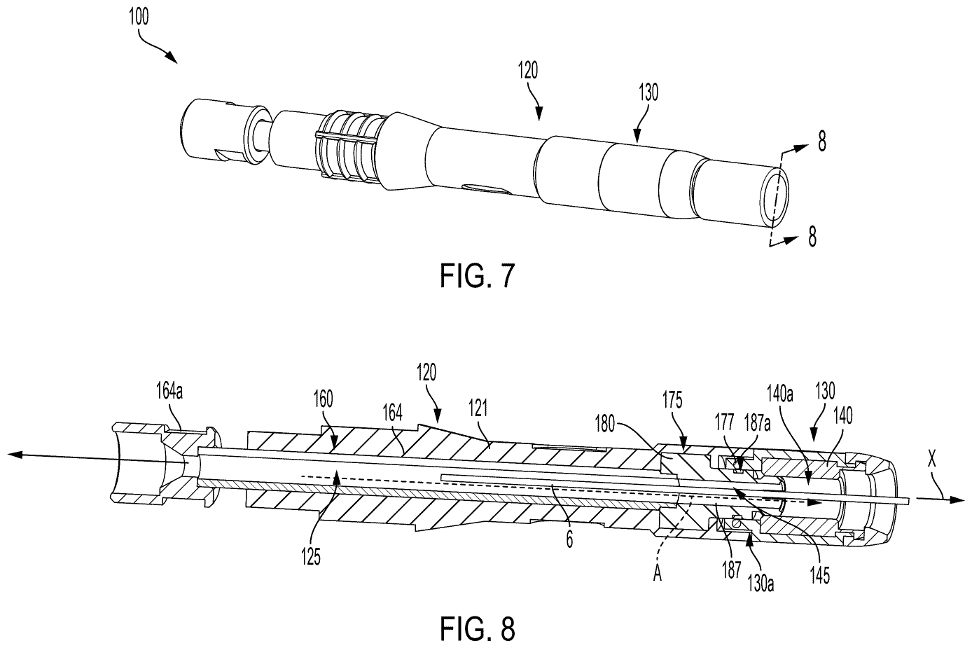

A radial opening 83 (FIG. 7) may extend between and connect the central cavity 85 and the opening 82 (FIG. 5) of the first body 80. In this manner, the radial opening 83 may define a passage for shielding gas (supplied via the gas line 62) to flow into the central cavity 85 (along flow path A). In some embodiments, the radial opening 83 is drilled into the first body from an exterior surface thereof, and subsequently capped via a plug 83b (e.g., brazed thereto) to preclude shielding gas from flowing out of the first body 82. It is contemplated that the radial opening 83 may be formed in other ways obviating the need for a plug 83b, for example, via a casting process (e.g., sand casting, die casting, etc.), electrical discharge machining (EDM), or any other suitable means therefor.

Referring to FIGS. 5 and 6, the first body 80 may include a stem 87 extending outwardly therefrom in a longitudinal direction. The stem 87 may at least partly define the central cavity 85 and a thread pattern 89 thereon adjacent to a distal end 87b thereof. One or more longitudinal slots 87c may be formed into the stem 87 adjacent to the distal end 87b to define flow passages for shielding gas to flow from the utility interface 75 into the head 30, as discussed in detail below.

As shown in FIG. 6, the head 30 may include a rigid insert 40 therein configured to retain torch expendables (e.g., a collet body 2, a collet 3, a heat shield 4 (FIG. 2), a nozzle 5 (FIG. 2) therefrom. For instance, the rigid insert 40 may define a cavity 42 with a female thread pattern 42b (FIG. 6) thereon (adjacent to a distal end 40b of the rigid insert 40) dimensioned to rotatably engage with a male thread pattern of the collet body 2. Because these examples of torch expendables are known in the art (and perform according to their typical functions), a detailed description thereof has been omitted for brevity.

As shown in FIG. 5, the rigid insert 40 may define an opening 42 with a female thread pattern 42a thereon (adjacent to a proximal end 40a of the rigid insert 50). In this manner, the opening 42 may be configured to rotatably engage with the thread pattern 89 of the utility interface 75 (threaded onto the stem 87 thereof) to secure the head 30 to the main body 20, thereby causing the collet 3 to grip and secure the non-consumable electrode 6 (FIG. 1) to the welding torch 10, e.g., to inhibit the non-consumable electrode 6 from moving in a longitudinal direction. In this manner, the head 30 of the welding torch 10 may also be removed when it is desirable to remove the non-consumable electrode (FIG. 1), for instance, when replacing a worn-out electrode, or changing non-consumable electrode types (e.g., a pure tungsten versus a thoriated tungsten) based on the particular type of welding process being performed, e.g., AC GTAW welding versus DC GTAW welding).

As shown in FIG. 6, the head 30 (e.g., the rigid insert 40 thereof) defines a central cavity 45 extending in a longitudinal direction that is substantially coaxial with the central cavities 25 and 85 of the main body 20 and the utility interface 75, respectively. In this manner, the central cavities 25, 45, and 85 may collectively define an elongated, central cavity of the welding torch 10 dimensioned to accommodate a standard length non-consumable electrode 6 (FIG. 2), e.g., a non-consumable electrode having a length that is at least about six inches, for example, a seven-inch tungsten electrode. In particular, the central cavity 25 of the main body 20 (at least partly defining the central cavity of the welding torch) may be formed into the polymeric material (i.e., the overmolded material) in a space between the utility lines of the welding torch 10, e.g., in a longitudinal space centrally located relative to the gas, power/coolant return, and coolant supply lines 62, 64, and 66, respectively. That is, each utility line may extend in a longitudinal direction that is adjacent to and spaced from the central cavity in a direction orthogonal to the longitudinal axis, e.g., such that the utility lines extend parallel relative to the cavity. In the embodiment shown, the central cavity 25 extends in a parallel manner relative to at least along a major portion of the utility lines 62, 64, and 66 between a proximal end 20a and a distal end 20b of the main body 20. For the purposes of this disclosure, a major portion means a portion or length that is greater than 50% of the total length between the proximal end 20a and the distal end 20b of the main body 20. In this manner, the welding torch 10 may accommodate a standard length non-consumable electrode in the longitudinal space between the utility lines defined by the central cavity 25.

An example operation of the welding torch 10 will now be described referring to FIG. 6. In use, shielding gas may be supplied into the central cavity 85 of the utility interface 75 along flow path A, whereupon the shielding gas is redirected into the head 30 of the torch 10 via the longitudinal slots 87c of the utility interface 75 (e.g. machined or formed into the stem 87 extending from the first body 80). Shielding gas may then flow downstream (e.g., toward the collet body 2 and into the nozzle 5 (e.g., via orifices in the collet body)). Welding current may then be transmitted to the non-consumable electrode 6 (FIG. 1) via the interface between first body 80 (e.g., via the stem 87 thereof) and the rigid insert 40 of the head 30, whereupon the current is then transmitted to the non-consumable electrode 6 via the collet 3 supported by the head 30. For this purpose, the utility interface 75 and the rigid insert 40 may comprise any suitable conductive material to transmit current therebetween, for example, copper or brass. In this manner, the welding torch 10 may be utilized to establish a welding arc between a distal end of the non-consumable electrode 6 and a weld puddle.

Turning now to FIGS. 7 and 8, another example of a welding torch 100 according to the present disclosure is shown. Similar features have been illustrated using similar reference numbers (e.g., 25→125, 75→175, etc.). Further still, a description of similar features has been omitted for brevity, except for the following differences.

The welding torch 100 may include a main body 120 with a utility assembly 160 therein. The utility assembly 160 may include a utility line 164 configured to supply welding current and shielding gas to the head 130 of the welding torch 100. In the embodiment shown, the welding torch 100 is devoid of a liquid-coolant supply or return line and embodies an air-cooled welding torch.

As shown in FIG. 7, the utility line 164 also defines a central cavity 125 dimensioned to receive a portion of a non-consumable electrode 6 therein. Specifically, the main body 120 may include a utility assembly 160 with a power/gas line 164 configured to supply welding current and shielding gas to the head 130 of the torch. The utility line 164 may comprise a connector 164a (e.g., a threaded fitting) dimensioned to connect to a flexible cable assembly (not shown) connecting the torch 100 to a welding power source.

Referring to FIG. 8, the utility interface 175 comprises a stem 187 protruding outwardly therefrom in a longitudinal direction. In this embodiment, the stem 187 defines a slot 187a extending around a circumference thereof dimensioned to receive a sealing member 177 (e.g., an O-ring). The sealing member 177 serves to prevent shielding gas supplied through the central cavity 125 from escaping the head 130 via an interface 130a between the head 130 and the main body 120. The main body 120 and the head 130 define central cavities 125 and 145, respectively, that collectively define a central cavity of the welding torch 100. In the embodiment shown, the utility line 164 and the rigid insert 140 may be overmolded via a polymeric material. Although it is contemplated that one or both of the main body 120 and the head 130 may comprise a rigid enclosure defining a cavity for the utility line 164 and the rigid insert 140.

An example operation of the welding torch 100 of the present embodiment is now described referring to FIG. 8. Shielding gas may be supplied to the head 130 of the torch (into the cavity 140a of the rigid insert 140) along a single flow path A via the central cavity 125 of the main body 120 (defined via the utility line 164) therein. Welding current may transmitted to the non-consumable electrode 6 via the interface between the utility interface 175 (via a conductive body thereof) and the rigid insert 140.

The various examples of welding torches (e.g., 10, 100) described herein include a main body 20, 120 that is configured to receive a rear, elongated portion of a standard length non-consumable electrode therein, without extending the length or size of the welding torch therefor. It is contemplated that the welding torches may embody hand-held gas tungsten arc welding (GTAW) or TIG welding torches. It should be appreciated that the various examples may also be employed in automated applications (e.g., hard automated TIG). Moreover, it is contemplated that the various inventive concepts disclosed herein may be applicable to TIG welding torches including integrated gas valves (e.g., to turn on or off the supply of shielding gas from a gas supply source). In this manner, it should be appreciated that the various inventions disclosed herein will be applicable to a wide variety of welding torches.

While the disclosed embodiments have been illustrated and described in considerable detail, it is not the intention to restrict or in any way limit the scope of the appended claims to such detail. It is, of course, not possible to describe every conceivable combination of components for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. A welding torch comprises:
an elongated body having a longitudinal axis and defining a cavity therein, wherein the cavity extends in a longitudinal direction and is dimensioned to receive a non-consumable electrode therein; and
a head configured to be removably attached to a distal end of the elongated body such that each of the head and the elongated body is aligned along the longitudinal axis, wherein the head is configured to secure the non-consumable electrode when the head is attached to the distal end of the elongated body.

2. The welding torch of claim 1, wherein the body comprises at least one utility line extending in the longitudinal direction, wherein the at least one utility line is spaced from the cavity in a direction orthogonal to the longitudinal direction, and wherein the at least one utility line extends parallel relative to the cavity.

3. The welding torch of claim 2, wherein the body comprises a polymeric material that is overmolded onto the at least one utility line, and wherein the polymeric material defines the cavity.

4. The welding torch of claim 2, wherein the at least one utility line includes a power utility line, a gas utility line, and a coolant utility line, wherein the cavity is coaxial with the longitudinal axis, and wherein each of the power utility line, the gas utility line, and the coolant utility line extends in the longitudinal direction and is spaced from the cavity in a direction orthogonal to the longitudinal direction.

5. The welding torch of claim 2, wherein the head includes a rigid insert therein, wherein the body includes a utility interface configured to receive a distal end of the at least one utility line, and wherein the utility interface is configured to engage the rigid insert to removably attach the head to the main body.

6. The welding torch of claim 1, wherein the head is configured to receive a collet therein to inhibit the non-consumable electrode from longitudinal movement when the head is attached to the main body.

7. The welding torch of claim 1, wherein the body includes a utility interface defining a portion of the cavity.

8. The welding torch of claim 1, wherein the body includes a utility interface therein, wherein the utility interface includes a body with a stem protruding outwardly therefrom in the longitudinal direction, and wherein the stem defines at least one slot dimensioned to enable shielding gas to flow from the utility interface to the head.

9. The welding torch of claim 1, wherein the body includes a utility interface therein, wherein the head includes a rigid insert therein defining an opening, wherein the utility interface includes a first body with a stem extending outwardly therefrom in the longitudinal direction, and wherein the stem is configured to rotatably engage the opening of the rigid insert to attach the head to the body.

10. The welding torch of claim 9, wherein the utility interface includes a second annular body affixed to the first body, and wherein the first body and the second annular body define an annular cavity therein for the passage of coolant.

11. The welding torch of claim 1, wherein the head includes a rigid insert therein, and wherein the rigid insert is overmolded with a polymeric material.

12. The welding torch of claim 1, wherein the head and the elongated body collectively define a cavity therein dimensioned to accommodate a tungsten electrode having a length of at least about six inches.

13. A GTAW torch comprises:
a body defining an elongated cavity therein extending longitudinally along a major length of the body; and
a head configured to be removably attached to the body, wherein each of the body and the head is aligned along a longitudinal axis of the body, wherein the elongated cavity is dimensioned to receive a non-consumable electrode therein.

14. The GTAW torch of claim 13 further comprising a utility line therein, wherein the utility line defines the elongated cavity.

15. The GTAW torch of claim 14, wherein the utility line is configured to supply shielding gas to the head via the elongated cavity.

16. The GTAW torch of claim 14, wherein the utility line is configured to transmit welding current to the head.

17. The GTAW torch of claim 13, wherein the head includes a rigid insert therein comprising a conductive material, and wherein the rigid insert is configured to transmit welding current to the non-consumable electrode via an expendable received by the rigid insert.

18. The GTAW torch of claim 13, wherein the elongated cavity is dimensioned to accommodate a portion of a tungsten electrode therein having a length that is at least about six inches.

19. A pencil-style welding torch comprises:
an overmolded first body extending along a longitudinal axis, wherein the overmolded first body defines a central cavity therein extending in a longitudinal direction and dimensioned to accommodate a portion of a non-consumable electrode comprising a length of at least about six inches; and
an overmolded head configured to be removably attached to the first body to inhibit the non-consumable electrode from longitudinal movement when the overmolded head is attached to the overmolded first body.

20. The pencil-style welding torch of claim 19, wherein the overmolded first body includes at least one utility line and a utility interface therein, wherein the utility interface is configured to receive an end of the at least one utility line, wherein the overmolded head comprises a rigid insert therein, and wherein the rigid insert is configured to connect to the utility interface to transmit welding current from the utility interface to the rigid insert.
